(19) United States
(12) Patent Application Publication
(10) Pub. No.: US 2003/0065928 A1
(43) Pub. Date: Apr. 3, 2003

(54) Method and apparatus for prefetching data during an encryption/decryption operation

(76) Inventor: Bedros Hanounik, San Jose, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/968,146

(22) Filed: Sep. 28, 2001

(51) Int. Cl. G06F 12/14

(52) U.S. Cl. 713/189

(57) ABSTRACT

To improve data encryption and/or decryption, data can be preloaded into an alternate storage area during a time that a data encryption/decryption operation is being performed. For example, while data in a first storage area is being encrypted or decrypted by a TDES processing core in a field programmable gate array, data can be loaded into a second storage area so that as soon as the data in the first storage area is encrypted/decrypted, the processing core can move on to the next set of data. While the data in the second storage area is being encrypted/decrypted, the data in the first storage area can be moved out and replaced with new data for the next data encryption/decryption operation.

### BACKGROUND OF THE INVENTION

The present invention pertains to the encryption and or decryption of data. More particularly, the present invention pertains to prefetching data during an encryption and/or decryption process.

There are a variety of encryption schemes known in the art. DES (Data Encryption Standard), is the name of the Federal Information Processing Standard (FIPS) 46-3, which describes the data encryption algorithm (DEA). The DEA is also defined in the ANSI (American National Standards Institute) standard X9.32. DES uses a 56-bit key to encrypt and decrypt 64-bit blocks of data. As known in the art, the DES algorithm is implemented with software and/or hardware components. In particular, the data to be encrypted is exclusive ORed (XOR) with the encryption key and forwarded to a substitution box (SBOX). In the SBOX, six bits of input data are replaced with a four-bit value depending on preset tables. Each of these tables is made up of sixteen columns and four rows of four-bit values (i.e., from 0 to 15 in decimal). To select the appropriate four-bit value, four of the bits of the input data are used to select one column and two of the bits are used to select a row. The corresponding four-bit value in the table is then output.

The output value of the SBOX is supplied to permutation box (PBOX) component, which performs a permutation operation on the concatenation of the output values from the SBOX component. In a DES system, these steps are repeated sixteen times. In a Triple DES system, these steps are repeated 48 times with up to three key values.

Systems for encrypting and decrypting data often include a DES or TDES “core”—a circuit specifically designed to take data to be encrypted or decrypted and output the appropriate data. The loading and storing of data before and after the DES or TDES encryption and decryption can take an excessive amount of time. Many application require the DES or TDES core to maintain a high bandwidth, which can be severely impacted by the loading a storing operations. Accordingly, there is a need for an improved method and apparatus for loading and storing data relative to a data encryption and/or decryption core.

### BRIEF DESCRIPTION OF THE DRAWINGS

FIG. 1 is a block diagram of a system for performing data encryption and/or decryption using a field programmable gate array (FPGA) according to an embodiment of the present invention.

FIG. 2 is a block diagram of a storage area to be coupled to a data encryption/decryption core according to an embodiment of the present invention.

FIG. 3 depict, schematically, the transfer of data between the loader, storage area, and DES processing core according to an embodiment of the present invention.

### DETAILED DESCRIPTION

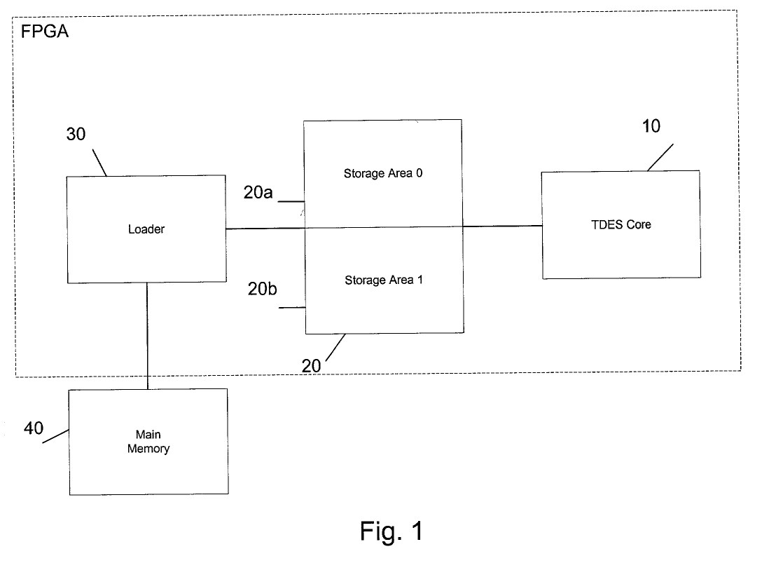

Referring to FIG. 1, a block diagram of a system for performing data encryption and/or decryption is shown. In this embodiment, the data encryption/decryption standard being used is the TDES standard described above. In this embodiment, the processing “core” is a TDES core 10 and is implemented on a Field Programmable Gate Array (FPGA). The processing core is coupled to a storage area 20. In this embodiment, the storage area 20 includes a first storage area 20a (Storage Area 0) and a second storage area 20b (Storage Area 1). The storage area is coupled to a loader 30 which pulls data to be encrypted and/or decrypted from a memory 40 of the like and places it in the appropriate space in the storage area 20. In this embodiment, the loader 30, storage area 20 and processing core 10 are implemented on the FPGA device. In other embodiments of the present invention, one or more of these components may be implemented outside of the FPGA device.

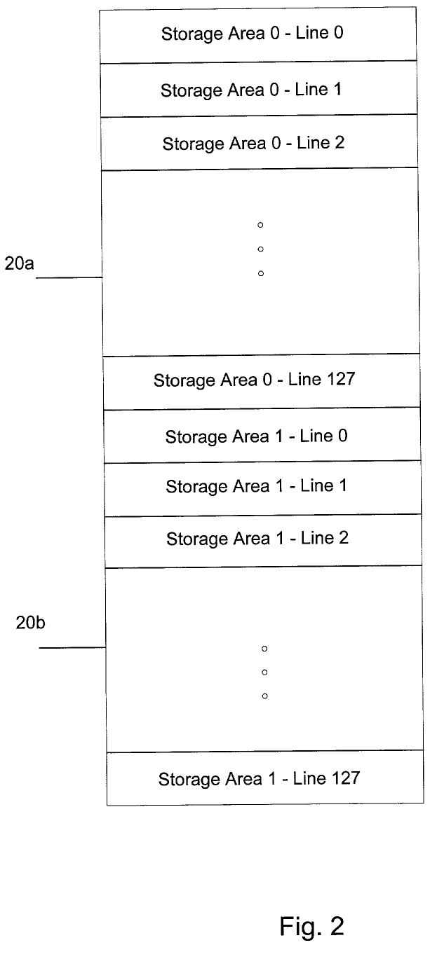

Referring to FIG. 2, a more detailed view of the storage area 20 is shown. In this embodiment, the storage area is made of 256 addressable lines, each containing 64 bits. The operation of the loader, storage area and TDES core can be divided into four stages. In the first stage, the loader 30 loads 64 bit data blocks into the 128 addressable locations (lines 0-127) of the first storage area (storage area 20a). In the second stage the TDES core 10 performs the encryption/decryption functions on the data in storage area 20a. In this embodiment, this is done by encrypting/decrypting the first 64-bit data block (in line 0) and continuing in sequence to the last 64-bit data block (in line 127). In this embodiment, the data processed from a given line is written back to the same line. Thus, for example, the 64-bit data block in line 0 is encrypted by the TDES core and written back to line 0. Over a period of time during the encryption/decryption operation, the second stage occurs where the loader 30 loads data into storage area 20b.

In the third stage, the TDES core 10 performs the encryption/decryption functions on the data in data storage area 20b after completing those functions on the data in data storage area 20a. In this embodiment, the output data from the TDES core 10 is written over the input data from the corresponding line of the storage area 20b. Over a period of time during the encryption/decryption operation, the loader 30 loads new data into storage area 20a, so that it can be processed by the TDES core soon after the data in storage area 20b is completed. Also, the loader may read the data in storage area 0 that has been processed by the TDES core 10 and store it in main memory 40.

In the fourth stage, the TDES core processes new data from storage area 20a. At some point during the encryption/decryption operation, the loader 30 loads new data into storage area 20b, so that it can be processed by the TDES core soon after the data in storage area 20a is completed. Also, the loader may store data processed by the TDES core 10 in main memory 40.

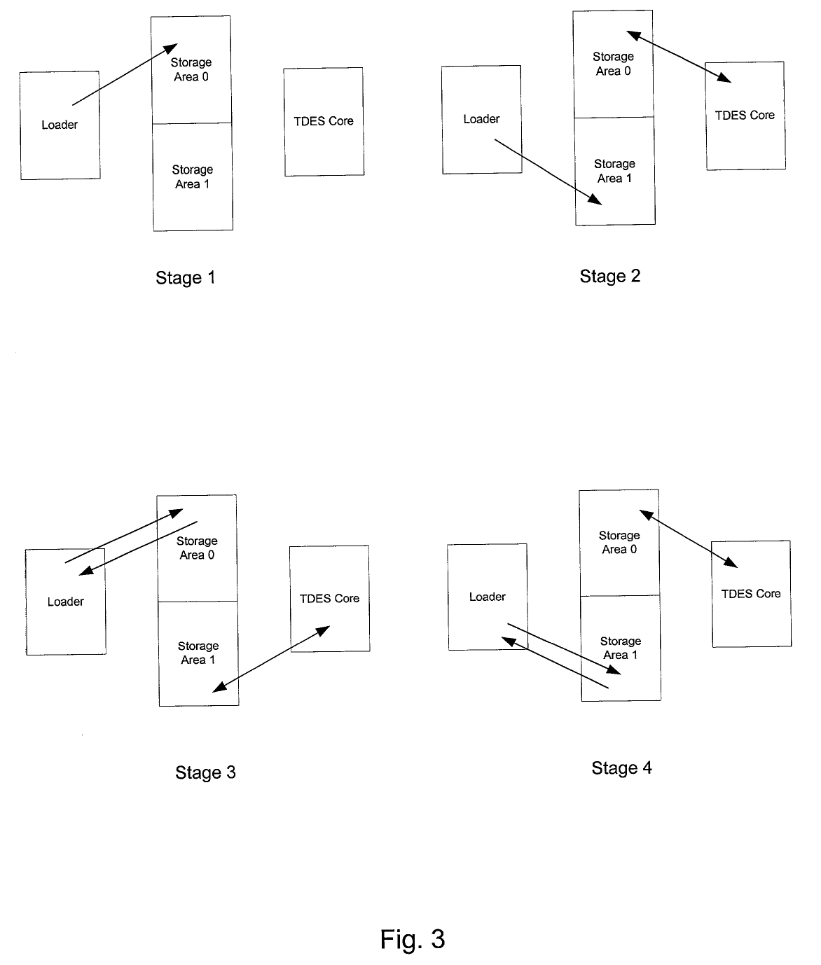

Referring to FIG. 3, a schematic diagram showing the transfer of data between the loader 30, the storage area 20, and the TDES core is shown for each of the four stages.

Although several embodiments are specifically illustrated and described herein, it will be appreciated that modifications and variations of the present invention are covered by the above teachings and within the purview of the appended claims without departing from the spirit and intended scope of the invention. For example, though the invention is described with respect to TDES, the invention can be expanded to other types of data encryption standards such as DES and AES (Advanced Encryption Standard; National Institute of Standards and Technology—Draft of February, 2001 available at http://www.nist.gov/aes).

What is claimed is:

1. A method of overlapping loading and storing operations while performing at least one of data encryption and data decryption, comprising:
loading data into a first storage area;
performing a first data operation including at least one of a data encryption operation and a data decryption operation on the data in said first storage area in a processing core of a programmable gate array; and
loading data into a second storage area during a period of time during said first data operation.

2. The method of claim 1 wherein said processing core is a Triple Data Encryption Standard core.

3. The method of claim 2 wherein said first storage area includes a number of storage lines, and said first data operation is performed on data in a first line of said storage area and stored in said first line of said storage area.

4. The method of claim 3, further comprising:
performing a second data operation including at least one of a data encryption operation and a data decryption operation on the data in said second storage area in the processing core; and
retrieving data from said first storage area during a period of time during said second data operation.

5. The method of claim 4, further comprising:
loading data into said first storage area during the period of time during the second data operation.

6. A circuit to perform at least one of data encryption and data decryption, comprising:
a programmable gate array including a processing core to perform a first data operation including at least one of a data encryption operation and a data decryption operation;
a storage area including at least first and second storage areas coupled to said processing core; and
a loader coupled to said first and second storage areas, said loader to store data in said first storage area wherein said processing core is to perform said first data operation on the data in said first storage area, and said loader to load data into said second storage area during a period of time during said first data operation.

7. The circuit of claim 6 wherein said processing core is a Triple Data Encryption Standard core.

8. The circuit of claim 7 wherein said first storage area includes a number of a number of storage lines, and said first data operation is performed on data in a first line of said storage area and stored in said first line of said storage area.

9. The circuit of claim 8 wherein said processing core is to perform a second data operation including at least one of a data encryption operation and a data decryption operation on the data in said second storage area and said loader is to retrieve data from said first storage area during a period of time during said second data operation.

10. The circuit of claim 9 wherein said loader is to load data into said first storage area during the period of time during the second data operation.

11. A field programmable gate array comprising:
a processing core to perform a first data operation including at least one of a data encryption operation and a data decryption operation;
a storage area including at least first and second storage areas coupled to said processing core; and
a loader coupled to said first and second storage areas, said loader to store data in said first storage area wherein said processing core is to perform said first data operation on the data in said first storage area, and said loader to load data into said second storage area during a period of time during said first data operation.

12. The circuit of claim 11 wherein said processing core is a Triple Data Encryption Standard core.

13. The circuit of claim 12 wherein said first storage area includes a number of a number of storage lines, and said first data operation is performed on data in a first line of said storage area and stored in said first line of said storage area.

14. The circuit of claim 13 wherein said processing core is to perform a second data operation including at least one of a data encryption operation and a data decryption operation on the data in said second storage area and said loader is to retrieve data from said first storage area during a period of time during said second data operation.

15. The circuit of claim 14 wherein said loader is to load data into said first storage area during the period of time during the second data operation.
